(19) United States
(12) Patent Application Publication
(10) Pub. No.: US 2020/0406467 A1
(43) Pub. Date: Dec. 31, 2020

(54) METHOD FOR ADAPTIVELY ADJUSTING A USER EXPERIENCE INTERACTING WITH AN ELECTRONIC DEVICE

(71) Applicant: Intuition Robotics, Ltd., Ramat-Gan (IL)

(72) Inventors: Shay ZWEIG, Harel (IL); Roy AMIR, Mikhmoret (IL); Itai MENDELSOHN, Tel Aviv-Yafo (IL); Dor SKULER, Oranit (IL)

(73) Assignee: Intuition Robotics, Ltd., Ramat-Gan (IL)

(21) Appl. No.: 16/913,598

(22) Filed: Jun. 26, 2020

Related U.S. Application Data
(60) Provisional application No. 62/866,808, filed on Jun. 26, 2019.

(51) Int. Cl. B25J 11/00; G06F 3/16; G06F 3/01; G06N 20/00

(52) U.S. Cl. CPC B25J 11/0005; G06N 20/00; G06F 3/017; G06F 3/167

(57) ABSTRACT

A method for adaptively adjusting a user experience interacting with an electronic device. A method includes: collecting, using at least one sensor, data related to an interaction of a user with a feature of an electronic device; activating of a timer to measure a response time of a user to the feature; analyzing the collected data to determine responsiveness of the user to the feature; and adjusting a user experience parameter of the electronic device based on the determined responsiveness.

### CROSS-REFERENCE TO RELATED APPLICATIONS

This application claims the benefit of U.S. Provisional Application No. 62/866,808 filed on Jun. 26, 2019, the contents of which are hereby incorporated by reference.

### TECHNICAL FIELD

The disclosure generally relates to improvements in user experiences for electronic devices and, more specifically, to a system and method for adjusting a user experience of an electronic device based on a user's response time to an interaction executed by the electronic device.

### BACKGROUND

Electronic devices, including personal electronic devices such as smartphones, tablet computers, consumer robots, smart appliances, and the like, have been recently designed with ever-increasing capabilities. Such capabilities fall within a wide range, including, for example, automatically cleaning or vacuuming a floor, playing high definition video clips, running applications with multiple uses, accessing the internet from various locations, controlling autonomous vehicles, and the like.

Such electronic devices usually have predetermined user experience parameters that are directed to a wide range of differing users, where users may differ in terms of age, medical condition, intelligence level, skill level in interacting with the electronic device, and the like. One disadvantage of applying predetermined user experience parameters is that such applications may cause users to become frustrated when the user experience parameters are not adapted to a user's skill level, intelligence, medical conditions, and the like. For example, an experienced user who is familiar with the properties of a robot that he or she has owned for more than three years may not be satisfied when the robot communicates with the experienced user in the same way that the robot would communicate with a new and unexperienced user.

An interaction with a new and unexperienced user may include, for example, detailed explanations for simple tasks executed by the robot. While such detailed explanations may be highly appreciated by a new user, an experienced user may find similar user experiences frustrating. In addition, where novice-level user experience interactions are required for users of all skill levels, such interactions may hinder the efficiency of the system including the user interface, requiring experienced users to dedicate time and attention to addressing novice-level system interactions before the system is configured to achieve the user's desired aims.

Therefore, it would be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for adaptively adjusting a user experience interacting with an electronic device. The method comprises: collecting, using at least one sensor, data related to an interaction of a user with a feature of an electronic device; activating of a timer to measure a response time of a user to the feature; analyzing the collected data to determine responsiveness of the user to the feature; and adjusting a user experience parameter of the electronic device based on the determined responsiveness.

Certain embodiments disclosed herein further include a non-transitory computer readable medium having stored thereon instructions for causing a processing circuitry to execute a process, the process comprising: collecting, using at least one sensor, data related to an interaction of a user with a feature of an electronic device; activating of a timer to measure a response time of a user to the feature; analyzing the collected data to determine responsiveness of the user to the feature; and adjusting a user experience parameter of the electronic device based on the determined responsiveness.

Certain embodiments disclosed herein also include a controller for adaptively adjusting a user experience when interacting with an electronic device. The electronic device comprises: a processing circuitry; and a memory, the memory containing instructions that, when executed by the processing circuitry, configure the system to: collect, using at least one sensor, data related to an interaction of a user with a feature of an electronic device; activate of a timer to measure a response time of a user to the feature; analyze the collected data to determine responsiveness of the user to the feature; and adjust a user experience parameter of the electronic device based on the determined responsiveness.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosure will be apparent from the following detailed description taken in conjunction with the accompanying drawings.

FIG. 1 is a network diagram utilized to describe the various embodiments of the disclosure

FIG. 2 is a block diagram depicting a controller configured to perform the disclosed embodiments.

FIG. 3 is a flowchart depicting a method for adjusting a user experience of an electronic device according to an embodiment.

### DETAILED DESCRIPTION

Below, exemplary embodiments will be described in detail with reference to the accompanying drawings so as to be easily realized by a person having ordinary skill in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

The various disclosed embodiments allow for adaptively adjusting a user experience of interaction with an electronic device in response to a user's response feedback from such a device. The method provided by the disclosed embodiments calls for collecting sensor data from a user response in response to a feedback from the electronic device and timing from the initiation of an output of the electronic device until the user's response is received. Based on the time measurements, a user experience parameter of the electronic device is adjusted.

In an embodiment, the electronic device is a social robot that can offer tips and advice, responding to questions, providing suggestions, and the like, in response to interaction with a user, such as an elderly person. The aim of the disclosure is to provide an enhanced solution for unpleasant and burdensome user experiences when interacting with the social robot. To this end, the data is collected using sensors internal or external to the robot, and the user's response time to an engagement that is executed by the electronic device is determined. Then, the user experience when interacting with the social robot is adjusted such that the user experience becomes more personalized, accurate, and better-suited to a user's medical conditions, intelligence level, skill level in interacting with the electronic device, and other, like, needs. For example, if, based on the collected data, the user is identified as partially deaf, the speaker volume of the robot may be adjusted to a higher volume, visual elements may be presented in addition to spoken elements, or both.

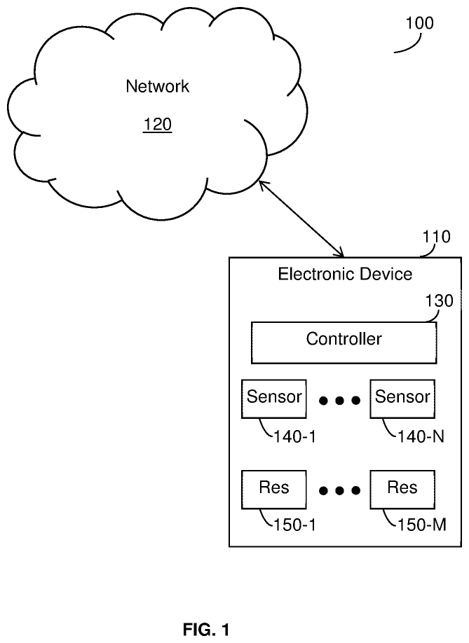

FIG. 1 is an example network diagram of an electronic agent system 100 utilized to describe the various embodiments of user experience adjustment for an electronic device 110.

The electronic device 110 may include a robot, a social robot, a service robot, a smart TV, a smartphone, a wearable device, a vehicle, a computer, a smart appliance, another, like, device, or any combination or subset thereof. Moreover, the electronic device 110 may be a combination of hardware, software, and firmware operable to provide the benefits described herein in greater detail. In a preferred embodiment, the device 110 is a social robot. An example implementation is discussed in U.S. patent application Ser. No. 16/507,599, which is assigned to the common assignee and is hereby incorporated by reference.

The electronic device 110 includes a controller (agent) 130 configured to perform the various embodiments for adjusting a user experience of the electronic device 110.

The electronic device 110 is connected to a network 120. The network 120 may be, but is not limited to, a local area network (LAN), a wide area network (WAN), a metro area network (MAN), the internet, a wireless, cellular, or wired network, other, like, networks, or any combination thereof. A user of the electronic agent system 100 may access the electronic device 110 directly, such as via a voice command or another input into a device connected directly or indirectly to the network 120.

The electronic device 110 and, thus, the controller 130, can operate with a plurality of sensors 140, marked 140-1 through 140-N, where N is a natural number, (hereinafter, “sensor” 140 or “sensors” 140), which allow direct or indirect input into the electronic device 110. Some sensors 140 may be integrated in the device 110, while some may be connected to the device 110 over the network 120. For example, but not by way of limitation, communication may occur by using a microphone as a sensor 140, such as, for example, sensor 140-1. Indirect communication may occur, by way of example but not by way of limitation, through an application on a mobile phone (not shown) communicatively connected to a sensor 140 such as, for example, sensor 140-2 (not shown), where the device 110, by means of the network 120, is additionally connected to the internet.

The device 110 may be further communicatively connected with a plurality of resources 150, marked 150-1 through 150-M, where M is a natural number (hereinafter, “resource” 150 or “resources” 150). The resources 150 may include, but are not limited to, display units, audio speakers, lighting systems, other, like, resources, and any combination thereof. In an embodiment, the resources 150 may encompass sensors 140 as well, or vice versa. That is, a single element may have the capabilities of both a sensor 140 and a resource 150 in a single unit. In an embodiment, the resources 150 may be an integral part of the electronic device (not shown), such that the electronic agent system 100 may be configured to use the resource of the electronic device 110 to communicate with the user.

As will be discussed in detail below, the controller 130 is configured to adjust a user experience based on interaction of a user with the electronic device 110. To this end, the controller 130 is configured to collect data related to an interaction with an electronic device, analyze the collected data, and adjust at least one user experience parameter of the electronic device 110 based on the result of the analysis.

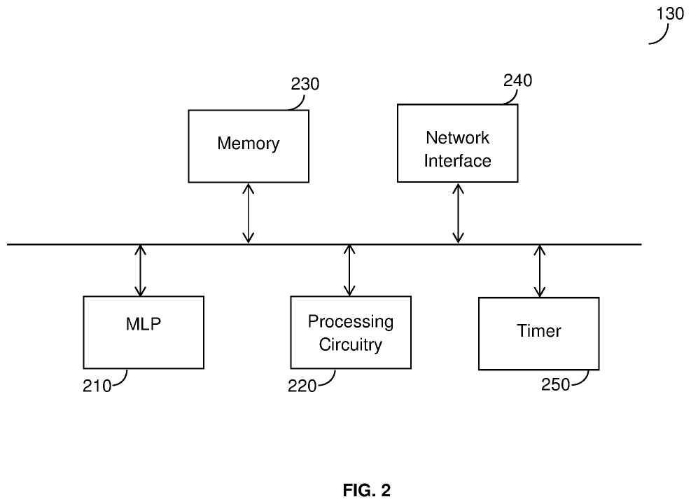

FIG. 2 depicts an example block diagram of the controller 130 configured to perform the disclosed embodiments, according to an embodiment. The controller 130 includes a machine learning processor (MLP) 210, a processing circuitry 220, a memory 230, network interface 240, and a timer 250.

The MLP 210 is configured to progressively improve the performance of the electronic device 110 by adaptively adjusting a user experience when interacting with an electronic device, as further described hereinbelow.

The MLP 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information, and may further comprise firmware components, software components, or both firmware components and software components, residing in memory.

In an embodiment, the MLP 210 is configured to process, train, and apply machine learning models as discussed herein. Training and utilizing such models is performed, in part, based on data received from the sensors 140 with respect to the human-machine interaction.

A processing circuitry 220 typically operates by executing instructions stored in a memory, such as the memory 230 described below, executing the various processes and functions the controller 130 is configured to perform. In an embodiment, the processing circuitry 220 may be realized as one or more hardware logic components and circuits. For example, and without limitation, illustrative types of hardware logic components that can be used include FPGAs, ASICs, ASSPs, SOCs, general-purpose microprocessors, microcontrollers, DSPs, and the like, or any other hardware logic components that can perform calculations or other manipulations of information, and may further comprise firmware components, software components, or both, residing in memory. In one embodiment, the MLP 210 and the processing circuitry 220 are integrated into a single unit for practical implementation and design considerations apparent to those of ordinary skill in the art. It should be noted that the output of the MLP 210 may be used by the processing circuitry 220 to execute at least a portion of at least one of the collecting processes, measuring processes, analyzing processes, and adjusting processes described further hereinbelow. The system 100 may be, as discussed herein, integrated into other electronic devices for the purpose of providing social interactions, such as those described in detail herein.

Specifically, the models and algorithms used to adapt the MLP 210 are tuned to analyze data that is collected from, for example, one or more sensors, such as the sensors 140, from the internet, social media, a user's calendar, other, like, sources, or any combination thereof, as further discussed herein. In an embodiment, the MLP 210 and the processing circuitry 220 are integrated into a single unit for practical implementation and design considerations apparent to those of ordinary skill in the art.

It should be noted that the output of the MLP 210 may be used by the processing circuitry 220 to execute at least a portion of the processes that are described hereinbelow. The system 100 may be, as discussed herein, integrated into other electronic devices for the purpose of adjusting a user experience when interacting with an electronic device as described herein in greater detail. In an embodiment, the MLP 210 is adapted, through the use of models and algorithms, to provide for the specific tasks of the system 100 as described herein. Specifically, the models and algorithms used to adapt the MLP 210 are tuned to provide an enhanced user experience by analyzing characteristics of the user's reactions to actionable outputs executed by an electronic device 110, as further discussed herein. In an embodiment, the MLP 210 may be communicatively connected to one or more sensors, such as the sensors 140, and other components of the system 100, via the network 120. In a further embodiment, the MLP 210 is configured to apply at least a learning algorithm to at least a sensor input received during an interaction between a user and an electronic device (e.g., an electronic social agent).

The memory 230 may contain therein instructions that, when executed by the processing circuitry 220, cause it to execute actions as described herein. The memory 230 may further store information, such as, as an example and without limitation, data associated with predetermined plans that may be executed by one or more resources, such as the resources 150.

In an embodiment, the memory 230 may further include a database which stores a variety of user experience parameters to be executed using the resources 150. A user experience parameter may be adjusted for the purpose of asking the user a question, explaining to the user a decision that was made by the system 100, and other, like, purposes. The adjusted user experience parameter may be executed using one or more resources, such as the resources 150.

In an example, the system 100 may use two different user experience parameters to collect information from experienced users of the system 100 and novice users of the system 100. In another non-limiting example, the system 100 may use two different user experience parameters to provide the same output, such as providing a specific recommendation, for two different users using the system 100, or other electronic devices to which the system 100 is communicatively connected. Specifically, in the above examples, user experience parameters related to different users provide for different presentations or executions of the same output, depending on the users' preferences, skill levels, and other, like, factors. Thus, where an output is, for example, a device operation instruction, an experienced user may receive a short and general output, while a new and less-experienced user may receive a long and detailed output.

In an embodiment, the timer 250 may be communicatively connected to the system 100, via the network 120, and may be used for measuring one or more users' response times for at least a portion of an interaction executed by the system 100, or other electronic devices to which the system 100 is communicatively connected. Users' response times, as determined via the timer 250, may be stored in a memory, such as the memory 230, for subsequent determination of the users' various skill levels, as well as for other, like, analyses.

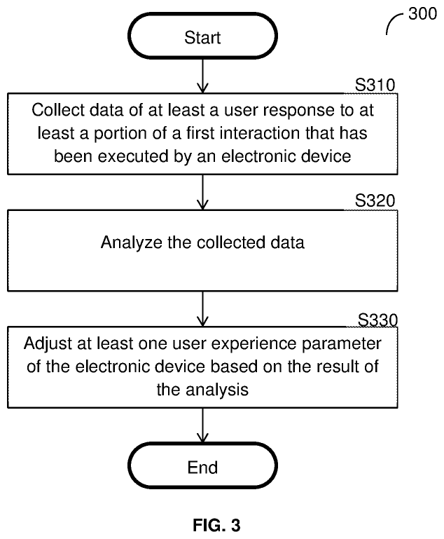

FIG. 3 is an example flowchart 300 depicting a method for adaptively adjusting a user experience of an electronic device, according to an embodiment.

At S310, user data, including at least a user response to at least a portion of an interaction that has been executed by an electronic device, is collected. The interaction may be implemented as, as examples and without limitation, a question, a statement, another, like, interaction, and any combination thereof, emitted by the electronic device, such as, as examples, and without limitation, a robot, an autonomous vehicle, and the like. Collected user response data may be, for example, a vocal response, a gesture, a facial expression, or another, like, response.

The process of collecting data may include activation of a timer, such as the timer, 250, of FIG. 2 above, that provides the ability for an electronic agent system, such as the electronic agent system, 100 of FIG. 1, above, to measure a user's response time for at least a portion of the executed first interaction. For example, the collected user response data may indicate that the user did not interrupt the electronic device until a certain explanation was completed by the electronic device. According to another example, the collected data may indicate that the user immediately started answering a question which was prompted by the electronic device before the question was fully provided to the user.

According to another example, the user's response time may be seven seconds. That is, in the same example, the user responded seven seconds after the question had been completed by the electronic device.

User response data, as collected at S310, may be formatted as, as examples and without limitation, responses matching the datatype expected for responses to the interactions executed, feedback data, generated via a separate process generated in response to the interactions executed, general user feedback describing the user's skill level or self-assessed skill level, other, like, data formats, and any combination thereof. Interactions may be executed by the electronic device with respect to one or more sensors, such as the sensors, 140-1 through 140-N, of FIG. 1, above, one or more resources, such as the resources, 150-1 through 150-M, of FIG. 1, above, other, like, components, and any combination thereof. Further, user responses may be collected as inputs received through one or more of the components described with respect to interaction execution, above.

At S320, the collected data is analyzed. In an embodiment, the analysis is achieved by applying at least one machine learning model on the collected data. S320 may include applying a trained machine learning model which identifies the user's response in real-time, or near real-time, whether the response is, as examples and without limitation, a vocal response, a gesture, a facial expression, or the like. The model may be trained based on feedback gathered and verified by other users. The trained model may be updated from time to time. In an embodiment, the trained model may classify a feedback (or interaction) with a user to a level of skill with a specific feature. The level of skill may be provided as a score. As an example, and without limitation, when the user tilts his or her head up and down, a trained machine learning model may interpret this kind of gesture as indication that the user is familiar with a certain explanation provided to him or her. As another example, also without limitation, when the user says “thank you, I know that” one second after a certain explanation is provided, the trained machine learning model may interpret this kind of vocal response as indicating a user's high level of knowledge with respect to the provided explanation.

According to another embodiment, analysis at S320 may be achieved by at least one predetermined rule. A plurality of predetermined rules may be stored in a memory, such as the memory, 230, of FIG. 1, above, a database, other, like, data storage media, and any combination thereof. Each predetermined rule may indicate a required at least one user experience parameter which relates to the collected data. As an example, and without limitation, a predetermined rule may state that, if a user initiates a response after more than four seconds after a question is completed by an electronic device, a user experience level associated with less experienced users is required. As another example, also without limitation, if the user initiates a response less than four seconds after a question is completed by an electronic device, a different user experience level, associated with more experienced users, is required. In an embodiment, the analysis of the collected data is performed to determine the responsiveness of the user to the feature.

At S330, at least one user experience parameter of the electronic device is adjusted, based on the results of the analysis executed at S320. User experience parameters may be related to, for example and without limitation, the skill level of the explanations provided by the electronic device, the resources by which a user interaction, executed by the electronic device is executed, the manner or style questions are asked, other, like, parameters, and any combination thereof. It should be noted that all user experience parameters of the electronic device may be adjusted based on the results of the analysis executed at S320. Alternatively, only a specific user experience parameter of the electronic device may be adjusted based on the results of the analysis conducted at S320. As an example, and without limitation, the results of the analysis may indicate that the user provided a reasonable and instantaneous feedback to an interaction executed by the electronic device and, therefore, all user experience parameters may be adjusted respectively. According to the same example, the adjustment may include providing, by the electronic device, less-detailed explanations, asking fewer questions, other, like, adjustments, and any combination thereof, to enhance the user experience of the electronic device. In an embodiment, the user experience parameter of the electronic device is adjusted based on the determined responsiveness.

In an embodiment, the analysis executed at S320 and applied to the determination of adjustments at S330 may also include analyzing the content of the at least a user response and determining the user's intent. The analysis of the content may be achieved using one or more machine learning techniques. The purpose of analyzing the content and determining the user's intent is to determine the quality of the user's response and, subsequently, adjust the user experience parameters of the electronic device more accurately in a way that suits the user, as at S330. For example, if the user provides a response to a suggestion prompted by the electronic device in less than two seconds, but the response is determined to be unreasonable, the adjustment of the user experience parameters at S330 may be different compared to a scenario in which the user's response is reasonable and provided within the same timeframe.

It should be noted that, as described herein, the term “machine learning model” may describe a model generated using, including, or both including and generated using, artificial intelligence (AI) methods that can provide computers with the ability to learn without being explicitly programmed. To this end, example machine learning models can be generated, trained, or programmed using methods including, but not limited to, fuzzy logic, prioritization, scoring, and pattern detection. The disclosed embodiments can be realized using one or more supervised learning models, the inputs of which are linked to outputs via a training data set, an unsupervised machine learning model, where an input data set is not initially labeled, a semi-supervised machine learning model, or any combination thereof.

It should be further noted that the method described herein may be executed at least periodically in order to maintain an accurate user experience that suits the user of the electronic device. By constantly monitoring the user's responses, a system, such as the system, 100, of FIG. 1, above, periodically analyzes the collected data and adjusts the user experience parameters of the electronic device respectively.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for adaptively adjusting a user experience interacting with an electronic device, comprising:
collecting, using at least one sensor, data related to an interaction of a user with a feature of an electronic device;
activating of a timer to measure a response time of a user to the feature;
analyzing the collected data to determine responsiveness of the user to the feature; and
adjusting a user experience parameter of the electronic device based on the determined responsiveness.

2. The method of claim 1, wherein collecting the data related to the interaction further comprises:
capturing a voice of the user using the at least one sensor, wherein the at least one sensor is a microphone.

3. The method of claim 2, wherein collecting the data related to the interaction further comprises:
capturing a gesture, a facial expression, or both using the at least one sensor, wherein the at least one sensor is a camera.

4. The method of claim 1, wherein each of the at least one sensor is any one of:
external to the electronic device and internal to the electronic device.

5. The method of claim 1, wherein adjusting the user experience parameter further comprises:
adjusting the user experience parameter to improve the user responsiveness to the feature.

6. The method of claim 5, wherein the feature includes any one of: functional, visual, and audio features of the electronic device.

7. The method of claim 6, wherein the electronic device is at least a social robot.

8. The method of claim 1, wherein determining the responsiveness of the user further comprises:
applying at least one predetermined rule on the collected data, wherein the predetermined rule is selected based on the feature.

9. The method of claim 1, wherein determining the responsiveness of the user further comprises:
applying at least one machine learning model on the collected data, wherein the at least one machine learning model provides the user experience parameter based on at least the collected data.

10. A non-transitory computer readable medium having stored thereon instructions for causing a processing circuitry to execute a process, the process comprising:
collecting, using at least one sensor, data related to an interaction of a user with a feature of an electronic device;
activating of a timer to measure a response time of a user to the feature;
analyzing the collected data to determine responsiveness of the user to the feature; and
adjusting a user experience parameter of the electronic device based on the determined responsiveness.

11. A controller for adaptively adjusting a user experience when interacting with an electronic device, comprising:
a processing circuitry; and
a memory, the memory containing instructions that, when executed by the processing circuitry, configure the system to:
collect, using at least one sensor, data related to an interaction of a user with a feature of an electronic device;
activate of a timer to measure a response time of a user to the feature;
analyze the collected data to determine responsiveness of the user to the feature; and
adjust a user experience parameter of the electronic device based on the determined responsiveness.

12. The controller of claim 11, wherein the system is further configured to:
capture a voice of the user using the at least one sensor, wherein the at least one sensor is a microphone.

13. The controller of claim 11, wherein the system is further configured to:
capture a gesture, a facial expression, or both using the at least one sensor, wherein the at least one sensor is a camera.

14. The controller of claim 11, wherein each of the at least one sensor is any one of:
external to the controller and internal to the electronic device.

15. The controller of claim 11, wherein the system is further configured to:
adjust the user experience parameter to improve the user responsiveness to the feature.

16. The controller of claim 15, wherein the feature includes any one of: functional, visual, and audio features of the electronic device.

17. The controller of claim 16, wherein the electronic device is at least a social robot.

18. The controller of claim 11, wherein the system is further configured to:
apply at least one predetermined rule on the collected data, wherein the predetermined rule is selected based on the feature.

19. The controller of claim 11, wherein the system is further configured to:
apply at least one machine learning model on the collected data, wherein the at least one machine learning model provides the user experience parameter based on at least the collected data.
